(19) United States
(12) Patent Application Publication
(10) Pub. No.: US 2009/0203401 A1
(43) Pub. Date: Aug. 13, 2009

(54) SELECTING AND PROPAGATING INFORMATION FROM PHONE TO ACCESSORY

(76) Inventor: John AHLINDER, Stockholm (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/028,872

(22) Filed: Feb. 11, 2008

(51) Int. Cl. H04B 1/38

(52) U.S. Cl. 455/557

(57) ABSTRACT

A method and apparatus for generating information at an external electronic device to be displayed on an accessory device is disclosed. The external electronic device receives registration information on at least one display area from the accessory device. The registration information is then stored in the external electronic device. When information to be displayed is received, a bitmap for information to be displayed is generated based on the stored registration information if the information is to be displayed on the accessory device. The generated bitmap is then transmitted to the accessory device.

### TECHNICAL FIELD OF THE INVENTION

The present invention relates to mobile phones and accessory devices and more particularly to a method and apparatus for displaying information on a mobile phone accessory display.

### DESCRIPTION OF RELATED ART

Mobile phones are becoming more complex with even greater functionality. To some extent this is also true for the mobile phone accessories which tend to, in addition to exploiting already existing phone functionality, want to utilize any new mobile phone functionality as well. Often, the accessories are interested in information made available in the mobile phone e.g., music track title information, caller ID, time and date, etc. With new technologies being added to the mobile phone, it is likely that such information is also interesting for accessories, e.g., temperature, altitude, pulse, navigation information, etc.

Up until now, adding new information elements to accessory devices has been solved by adding information-type dependant communication software to both the accessory device and the mobile phone. For example, consider a mobile phone which can show pulse/heart-beat information. This information can also be shown on an accessory device, e.g., a watch by implementing this feature on both the mobile phone and the accessory device. For example, a new AT command implementation was added to both mobile phone software and accessory device software to enable the accessory to display music track title information from the mobile phone. This work was also preceded by requirement and specification work. The solution involves numerous interactions between the mobile phone and accessory device. First, the accessory device must subscribe for track title information and the mobile phone acknowledges the request. The track title information is sent to the accessory device. The accessory device then sends the track title information back to the mobile phone with a request to generate a bitmap. The mobile phone generates the bitmap and sends the bitmap to the accessory device. Finally, the accessory device shows the track title information in a display on the accessory device.

There are several problems with the above-described implementation. First, older accessory devices can not display the information without the new communication software. It also requires coordination and timing between accessory device and mobile phone developers so that desired mobile phones and accessory devices with the new functionality is made available at the same time. Finally, by introducing complicated software on both the accessory device and the mobile phone, the risk for introducing software bugs and compatibility issues increase steadily.

Thus, there is a need for a method and apparatus for displaying information on accessory devices without the need for new and/or complicated software on the accessory device.

### SUMMARY OF THE INVENTION

According to some embodiments of the invention, a method for generating information at an external electronic device to be displayed on an accessory device is disclosed. The method comprises the steps of: receiving registration information on at least one display area from the accessory; storing said registration information; receiving information to be displayed; generating a bitmap for information to be displayed based on the stored registration information if the information is to be displayed on the accessory device; and transmitting the generated bitmap to the accessory device.

According to another embodiment of the invention, an external electronic device for generating information to be displayed on an accessory device is disclosed. The external electronic device comprises: a transceiver for receiving registration information on at least one display area from the accessory; a memory for storing said registration information; said transceiver for receiving information to be displayed; a microprocessor for generating a bitmap for information to be displayed based on the stored registration information if the information is to be displayed on the accessory device; and said transceiver for transmitting the generated bitmap to the accessory device.

According to another embodiment of the invention, a method for displaying information on a display of an accessory device to an external electronic device is disclosed. The method comprises the steps of: determining display size and type information for each display on the accessory device; transmitting said display size and type information to the external electronic device; receiving a generated bitmap from the mobile phone; and displaying the generated bitmap.

Further embodiments of the invention are defined in the dependent claims.

It is an advantage of embodiments of the invention that an accessory can now display any information that the external electronic device can create without the need for the accessory device having the functionality of the external electronic device.

### BRIEF DESCRIPTION OF THE DRAWINGS

Further objects, features and advantages of embodiments of the invention will appear from the following detailed description of the invention, reference being made to the accompanying drawings, in which:

FIG. 1 illustrates a wireless communication system for use by the invention;

FIG. 2 illustrates a digital watch according to one embodiment of the invention;

FIG. 3 is a flow chart describing the operation of the external electronic device and accessory device according to one embodiment of the invention; and

FIG. 4 illustrates a menu of options which are displayed on the external electronic device according to one embodiment of the invention; and

FIG. 5 illustrates a plurality of menus of options displayed on the external electronic device according to one embodiment of the invention.

### DETAILED DESCRIPTION OF EMBODIMENTS

Specific illustrative embodiments of the invention will now be described with reference to the accompanying drawings. This invention may, however, be embodied in many different forms and should not be construed as limited to the embodiments set forth herein. Rather, the disclosed embodiments are provided so that this specification will be thorough and complete, and will fully convey the scope of the invention to those skilled in the art. The terminology used in the detailed description of the particular embodiments illustrated in the accompanying drawings is not intended to be limiting of the invention. Furthermore, in the drawings like numbers refer to like elements.

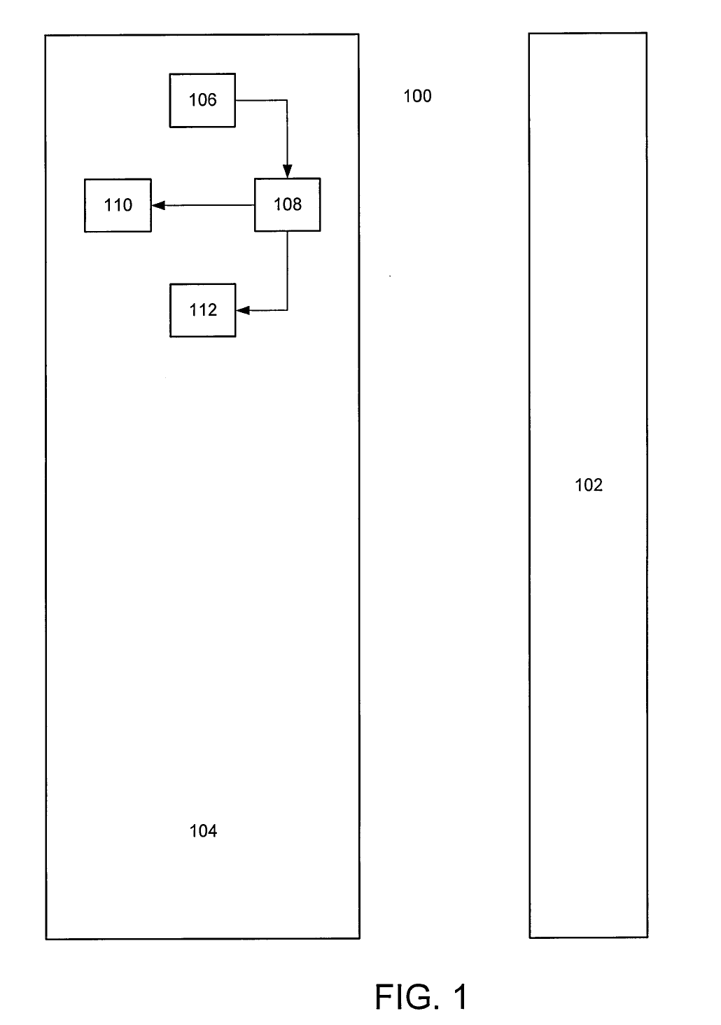

FIG. 1 illustrates a wireless communication system 100 within which the invention may operate. While the invention will now be described as using a Bluetooth wireless system, it will be understood by those skilled in the art that the invention can operate in various wireless systems and the invention is not limited thereto. Bluetooth is basically a wireless personal area network technology, which is an open standard for short-range transmission of digital voice and data between predominately mobile devices, such as laptops, Personal Digital Assistants (PDAs), and mobile phones, and also between mobile devices and stationary devices, and between stationary devices, such as printers, computers, fax machines and so on. Bluetooth supports point-to-point and multipoint applications. Bluetooth typically provides up to 720 Kbps data transfer within a range of 10 meters and up to 100 meters with a power boost. Bluetooth uses omni-directional radio waves that can transmit through walls and other non-metal barriers in the unlicensed 2.4 GHz band. In this embodiment, an accessory device 102 such as a watch is in communication with an external electronic device 104. The external electronic device 104 may be a computer, PDA, mobile phone, etc., and the invention is not limited thereto. The external electronic device 104 comprises, among other features, a transceiver 106 for communicating with various communication systems and one or more accessory devices 102. The transceiver 106 is connected to at least one microprocessor 108 which is programmed to perform the various functions of the external electronic device 104. The microprocessor 108 is connected to a memory 110 and at least one display 112. The external electronic device 104 transmits information to the accessory for display on the accessory 102 as will be explained in more detail below.

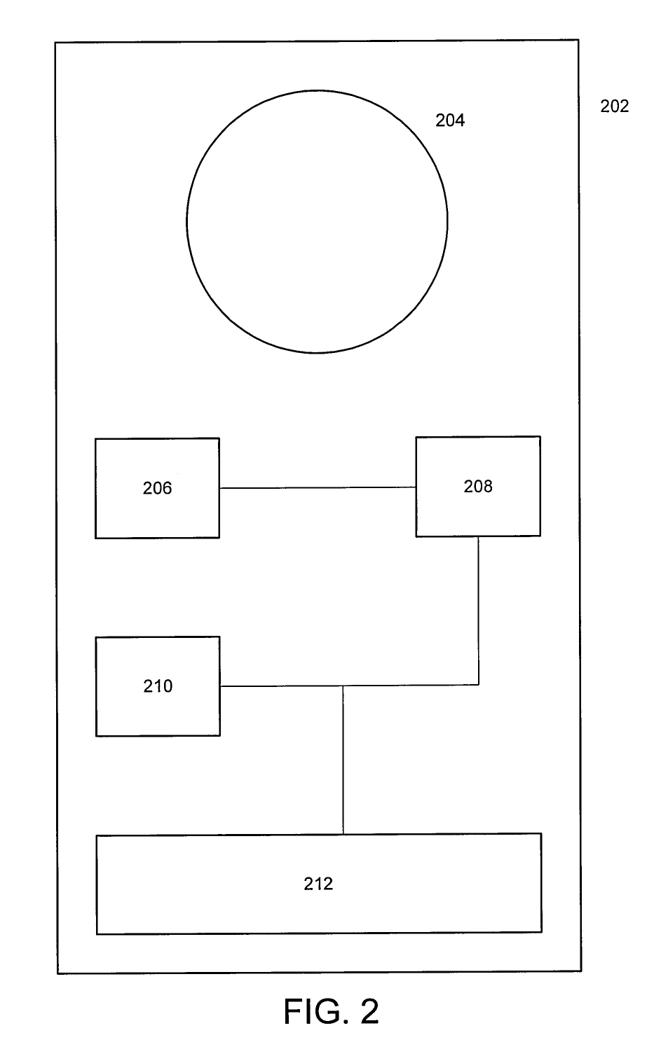

FIG. 2 illustrates an exemplary accessory device which is a watch 202 according to one embodiment of the invention, but the invention is not limited thereto. The watch 202 has a typical watch face 204 on which the time is displayed. The watch face may have the traditional layout illustrated in FIG. 2 but the invention is not limited thereto. The watch 202 comprises a transceiver 206 for communicating with one or more external electronic devices 104. The transceiver 206 is connected to at least one microprocessor 208 which is programmed to perform various functions on the watch 202. The microprocessor 208 is connected to a memory 210 and at least one display 212 and may be connected to other parts of the watch which are not illustrated. The display(s) 212 can be located anywhere on the watch 202 and the invention is not limited thereto.

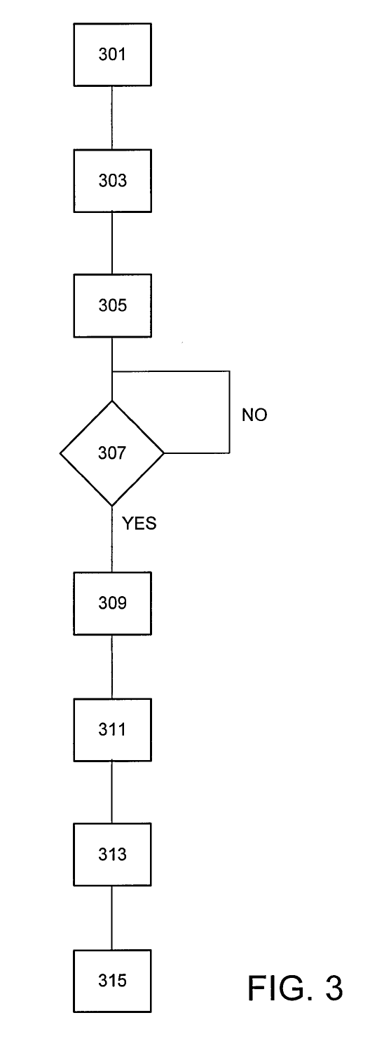

According to one embodiment of the invention, a method for selecting and displaying information on a display of an accessory device will now be described with reference to FIG. 3. In step 301, the accessory device 102 determines how many displays it has available. It will be understood that the accessory may have any number of displays and a single display may be divided into a plurality of different displays. It is not important that the mobile phone knows whether each display is a separate display or is a divided display. In step 303, the accessory device 102 transmits the display information to the external electronic device 104 via a connection such as a Bluetooth connection. The external electronic device 104 stores the display information in the memory 110 for later use.

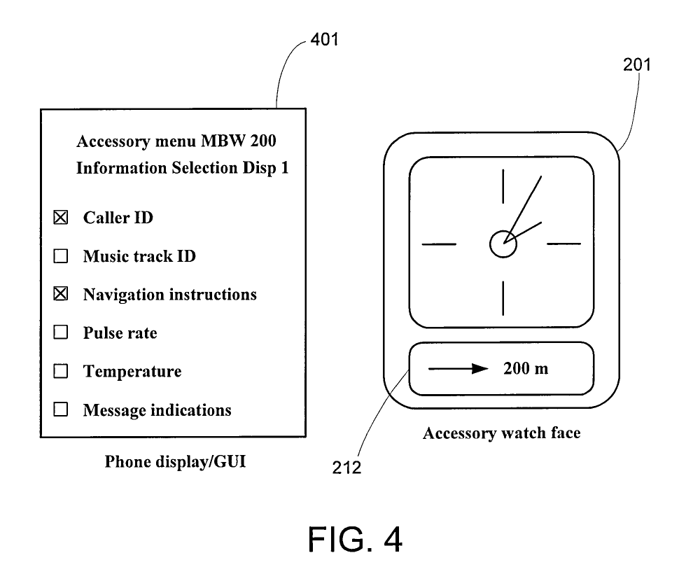

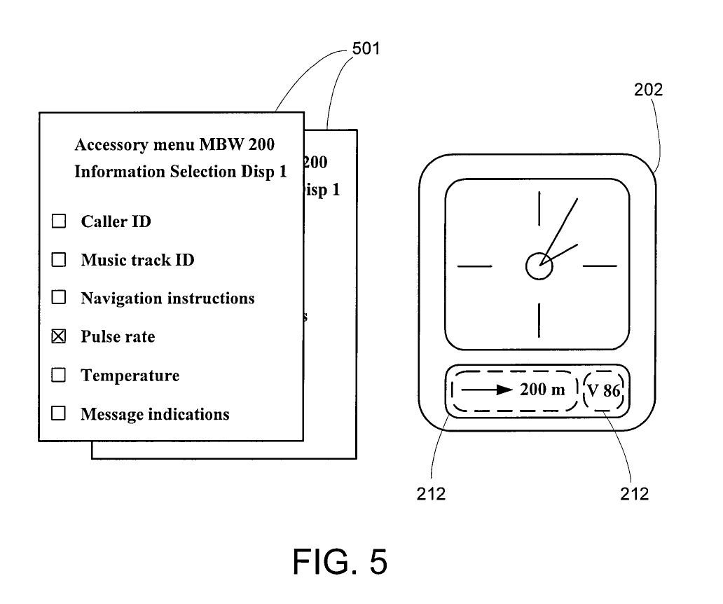

According to one embodiment of the invention, the user of the external electronic device 104 can select what type of information should be displayed on the accessory display(s) based on the capabilities and functions of the external electronic device 104 in step 305. For example, the external electronic device 104 may display on the display 112 a list or menu of options that can be displayed on the accessory device 102. As illustrated in FIG. 4, the menu list of options 401 may include but is not limited to caller ID, music track ID, navigation instructions, pulse rate, temperature, message indication, etc. The user simply selects from the list which options the user wants to have displayed on the accessory device when the information is available. Furthermore, the user may prioritize which options should be displayed in a display when information from several selected options are available at the same time. In addition, the external electronic device 104 may display a plurality of option menus 501 that are available for each display of the accessory as illustrated in FIG. 5. This way the user can decide where the options will be displayed on the accessory device.

The external electronic device 104 then waits, in step 307, for information pertaining to the options and functions of the external electronic device 104 to either be received from an external service or is generated by the external electronic device 104 itself. The external communication service can be any external computer which transmits information to the external electronic device 104. Once information is received by the transceiver 106, the microprocessor 108 checks to see if the information should be displayed on the accessory device 102 in step 309. If the received information is to be displayed on a display on the accessory device 102, the microprocessor 103 looks at the display type and size information stored in the memory 110 for the selected display and generates a bitmap for the received information based on the characteristics of the display in step 311. Once created, the bitmap is transmitted to the accessory device 102 with an indication on which display on the accessory the bitmap should be displayed in step 313. The accessory device 102 then displays the received bitmap in the appropriate display in step 315. It is important to note that the accessory is simply displaying the bitmap received from the external electronic device 104 and does not need the functionality for creating the bitmap for the information. It will be understood by one skilled in the art that in addition to displaying the received information on the display of the accessory, the received information can also be displayed on the display 112 of the external electronic device 104.

Although the embodiments of the present invention described with reference to the drawings comprise a watch 102 and an external electronic device 104 and processes performed in the watch 102 and the external electronic device 104, the invention also extends to a computer program product, which enables implementation of the method and functions described herein. The invention may be carried out when the computer program product is loaded and executed in a system having computer capabilities. Computer program, software program, program product, or software, in the present context mean any expression, in any programming language, code or notation, of a set of instructions intended to cause a system having a processing capability to perform a particular function directly or after conversion to another language, code or notation.

The present invention has been described above with reference to specific embodiments. However, other embodiments than the above described are equally possible within the scope of the invention. Different method steps than those described above, performing the method by hardware or software or a combination of hardware and software, may be provided within the scope of the invention. It should be appreciated that the different features and steps of the invention may be combined in other combinations than those described. The scope of the invention is only limited by the appended patent claims.

1. A method for generating information at an external electronic device to be displayed on an accessory device, comprising the steps of:
receiving registration information on at least one display area from the accessory;
storing said registration information;
receiving information to be displayed;
generating a bitmap for information to be displayed based on the stored registration information if the information is to be displayed on the accessory device; and
transmitting the generated bitmap to the accessory device.

2. A method according to claim 1, wherein at least on menu listing possible information which can be displayed on the accessory device is displayed on the external electronic device.

3. A method according to claim 2, wherein a user of the mobile phone selects information to be displayed on the accessory from said at least one menu.

4. A method according to claim 1, wherein the registration information comprises display size and type information for each display on the accessory.

5. A method according to claim 1, wherein the external electronic device is one of a computer, PDA, and mobile phone.

6. A method according to claim 1, wherein said accessory device is a watch.

7. A method according to claim 1, wherein the information to be displayed comprises one or more of caller ID, music track ID, navigation instructions, pulse rate, temperature, message indication.

8. An external electronic device for generating information to be displayed on an accessory device, comprising:
a transceiver for receiving registration information on at least one display area from the accessory;
a memory for storing said registration information;
said transceiver for receiving information to be displayed;
a microprocessor for generating a bitmap for information to be displayed based on the stored registration information if the information is to be displayed on the accessory device; and
said transceiver for transmitting the generated bitmap to the accessory device.

9. An external electronic device according to claim 8, wherein at least on menu listing possible information which can be displayed on the accessory device is displayed on the external electronic device.

10. An external electronic device according to claim 9, wherein a user of the mobile phone selects information to be displayed on the accessory from said at least one menu.

11. An external electronic device according to claim 8, wherein the registration information comprises display size and type information for each display on the accessory.

12. An external electronic device according to claim 8, wherein the external electronic device is one of a computer, PDA, and mobile phone.

13. An external electronic device according to claim 8, wherein said accessory device is a watch.

14. An external electronic device according to claim 8, wherein the information to be displayed comprises one or more of caller ID, music track ID, navigation instructions, pulse rate, temperature, message indication.

15. A method for displaying information on a display of an accessory device to an external electronic device, comprising the steps of:
determining display size and type information for each display on the accessory device;
transmitting said display size and type information to the external electronic device;
receiving a generated bitmap from the mobile phone; and
displaying the generated bitmap.

16. A method according to claim 16, wherein the generated bitmap displays information from the external electronic display device.

17. A computer program product comprising program instructions for causing a computer system to perform the method of claim 1 when said program is run on a computer system.

18. A computer product according to claim 17, embodied on a record medium, stored in a computer memory, embodied in a read-only memory, or carried on an electrical carrier signal.

19. A computer program product comprising a computer readable medium, having thereon: computer program code means wherein said program is loaded, to make the computer system execute the method of claim 1.
